(19) United States
(12) Patent Application Publication
(10) Pub. No.: US 2007/0019292 A1
(43) Pub. Date: Jan. 25, 2007

(54) Hybrid-type polarizer, method of manufacturing the same and display device having the same

(75) Inventors: Woo-Jun Kim, Gyeonggi-do (KR); Tae-Seok Jang, Seoul (KR); Jin-Sung Choi, Choongcheongnam-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/490,222

(22) Filed: Jul. 19, 2006

(30) Foreign Application Priority Data
Jul. 19, 2005 (KR) 2005-65078

(51) Int. Cl. G02B 5/30

(52) U.S. Cl. 359/486; 359/483

(57) ABSTRACT

In a hybrid-type polarizer having a reflective-type polarizing filter and a color filter, a method of manufacturing the hybrid-type polarizer and a display device having the hybrid-type polarizer, the hybrid-type polarizer includes a base member and a polarizing color filter member. The polarizing color filter member includes a plurality of metal gratings in a plurality of regions of the base member. The metal gratings in the regions have different sizes from each other. Each of the metal gratings transmits a first portion of an incident light and reflects a second portion of the incident light. The invention improves image display quality and lowers the manufacturing cost.

### CROSS-REFERENCE TO RELATED APPLICATION

The present application claims priority from Korean Patent Application No. 2005-65078, filed on July 19, 2005, the disclosure of which is hereby incorporated herein by reference in its entirety.

### BACKGROUND OF THE INVENTION

1. Field of the Invention

The present invention relates generally to a hybrid-type polarizer and more particularly to a hybrid-type polarizer having a reflective-type polarizing filter and a color filter.

2. Description of the Related Art

While liquid crystal display (LCD) devices are popular flat panel displays with many advantages, there are aspects of these devices that could be improved. For example, the efficiency with which light is used for the display could be higher. An LCD device displays an image using the polarizing characteristics of liquid crystals, and often includes one or more polarizers to control light transmission. A polarizer of the LCD device blocks about 50% of the light from a light source, unless the light source is a laser beam generator that generates already-polarized light. Although energy is consumed to generate the blocked portion of the light, the blocked portion does not contribute to the image that is displayed and therefore represents a “waste.” More of the generated light is lost when it passes through the polarizer but is blocked by red, green and blue sub-pixels that form a unit pixel.

Numerous techniques have been developed to reduce the amount of light that is wasted. One such technique is a reflective-type polarizer or a reflective-type color filter made of a stack of films. The plurality of films in the reflective-type polarizer or the reflective-type color filter have different refractive indexes from each other. Another such technique is a polarizer having a cholesteric liquid crystal.

However, the reflective-type polarizer, the reflective-type color filter and the polarizer having the cholesteric liquid crystal also transmit only a portion of the light having a predetermined wavelength range, and block the remaining portion of the light having different wavelengths. Thus, even with these techniques, much of the light ends up not contributing to the luminance of the LCD device.

It is desirable to further reduce the portion of light that is wasted in an LCD device, thus improving the display luminance and power usage efficiency.

### SUMMARY OF THE INVENTION

The present invention provides a hybrid-type polarizer having a reflective-type polarizing filter and a color filter capable of improving polarizing characteristics such as a polarization extinction ratio and a reflective ratio.

The present invention also provides a method of manufacturing the above-mentioned hybrid-type polarizer.

The present invention also provides a display device having the above-mentioned hybrid-type polarizer.

In one aspect, the present invention is a hybrid-type polarizer including a base member and a polarizing color filter member. The polarizing color filter member includes a plurality of metal gratings in a plurality of regions of the base member. The metal gratings in the regions have different sizes from each other. Metal gratings in each of the regions transmit a first portion of an incident light and reflect a second portion of the incident light. The hybrid-type polarizer may further include a protecting layer that covers the metal grating.

In another aspect, the invention is a method of manufacturing a hybrid-type polarizer. The method entails preparing a master mold that includes a plurality of patterns in first, second and third regions of a base. The patterns in the first, second and third regions have different sizes from each other. A metal layer is deposited on a substrate. A polymer layer is formed on the metal layer. The patterns of the master mold are imprinted on the polymer layer. The metal layer is partially etched using the patterned polymer layer as an etching mask.

In another aspect, the method entails preparing master mold that includes a plurality of protrusions in first, second and third regions of a base. The protrusions in the first, second and third regions have different sizes from each other. A polymer layer is formed on a substrate. The protrusions of the master mold are imprinted on the polymer layer to form grooves in the polymer layer. A metal layer is deposited on the imprinted polymer layer, filling the grooves. The metal layer is planarized through a chemical mechanical polishing or a wet etching so that a portion of the printed polymer layer is exposed. A protecting layer is coated on the exposed polymer layer and the metal layer.

In yet another aspect, the method entails preparing a master mold. A master mold includes a plurality of protrusions in first, second and third regions of a base. The protrusions in the first, second and third regions have different sizes from each other. A polymer layer is formed on a base film. The protrusions of the master mold are imprinted on the polymer layer to form grooves in the polymer layer. A metal layer is deposited on the printed polymer layer, filling the grooves. A substrate is attached so that the metal layer contacts the substrate. The base film is detached from the polymer layer. A protecting layer is coated on the polymer layer.

In yet another aspect, the method entails depositing a silicon oxide layer on a substrate, depositing a first metal layer on the silicon oxide layer, and coating a first photoresist layer on the first metal layer. Portions of the first photoresist layer are selectively removed to form a first photoresist mask, and the first metal layer and the silicon oxide layer are etched using the first photoresist mask to form a first patterned metal layer and a patterned silicon oxide layer. The first photoresist mask and the first patterned metal layer are removed to expose the patterned silicon oxide layer. A second metal layer is deposited over the patterned silicon oxide layer, the second metal layer having a planar surface. A second photoresist layer is formed on the second metal layer and patterned to form a second photoresist mask, the second photoresist mask protecting less surface than the first photoresist mask. The second metal layer is etched using the second photoresist mask to form a second patterned metal layer, wherein the second patterned metal layer is formed only on select parts of the patterned silicon oxide layer. The method entails removing the second photoresist mask to leave tall protrusions and short protrusions, tall protrusions made of the patterned silicon oxide layer and the second patterned metal layer and the short protrusions made of the patterned silicon oxide layer.

In yet another aspect, the invention is a display device that includes a backlight unit, a liquid crystal display panel and a hybrid-type polarizer. The backlight unit generates a light. The liquid crystal display panel is on the backlight unit. The liquid crystal display panel includes two substrates and a liquid crystal layer interposed between the two substrates. The hybrid-type polarizer is interposed between the backlight unit and the liquid crystal display panel. The hybrid-type polarizer includes a base member and a polarizing color filter member. The polarizing color filter member includes a plurality of metal gratings in a plurality of regions of the base member. The metal gratings are in the regions having different sizes from each other. Each of the metal gratings transmits a first portion of the light and reflects a second portion of the light.

According to the present invention, the hybrid-type polarizer has a mono-layered structure that functions as a reflective-type polarizing filter and a color filter to improve the image display quality of a display device. The hybrid-type polarizer may have the metal grating having a micro-structure. Using the hybrid-type polarizer decreases the manufacturing cost of the display device.

### BRIEF DESCRIPTION OF THE DRAWINGS

The above and other advantages of the present invention will become more apparent by describing in detail example embodiments thereof with reference to the accompanying drawings, in which:

FIG. 1 is a cross-sectional view illustrating a hybrid-type polarizer in accordance with one embodiment of the present invention;

FIGS. 2A and 2B are perspective views illustrating transmission and reflection of a zero order metal grating;

FIG. 3 is a cross-sectional view illustrating a display device having a hybrid-type polarizer in accordance with one embodiment of the present invention;

FIG. 4 is a cross-sectional view illustrating an operation of the display device shown in FIG. 3;

FIG. 5 is a graph comparing the light transmittance of a metal grating to the light transmittance of transmissive-type color filters as a function of wavelength;

FIG. 6 is a graph illustrating the polarization extinction ratio as a function of wavelength, the wavelength being of a second polarized light that is polarized by the metal grating in accordance with one embodiment of the present invention;

FIGS. 7A to 7E are cross-sectional views illustrating a method of manufacturing a hybrid-type polarizer in accordance with one embodiment of the present invention;

FIGS. 8A to 8I are cross-sectional views illustrating a method of manufacturing a master mold shown in FIG. 7A with alternative protrusions;

FIGS. 9A to 9E are cross-sectional views illustrating a method of manufacturing a hybrid-type polarizer in accordance with another embodiment of the present invention; and

FIGS. 10A to 10G are cross-sectional views illustrating a method of manufacturing a hybrid-type polarizer in accordance with another embodiment of the present invention.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “attached to,” “connected to,” or “coupled to” another element or layer, it can be directly on, attached, connected or coupled to the other element or layer or intervening elements or layers may be present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

Hybrid-type Polarizer

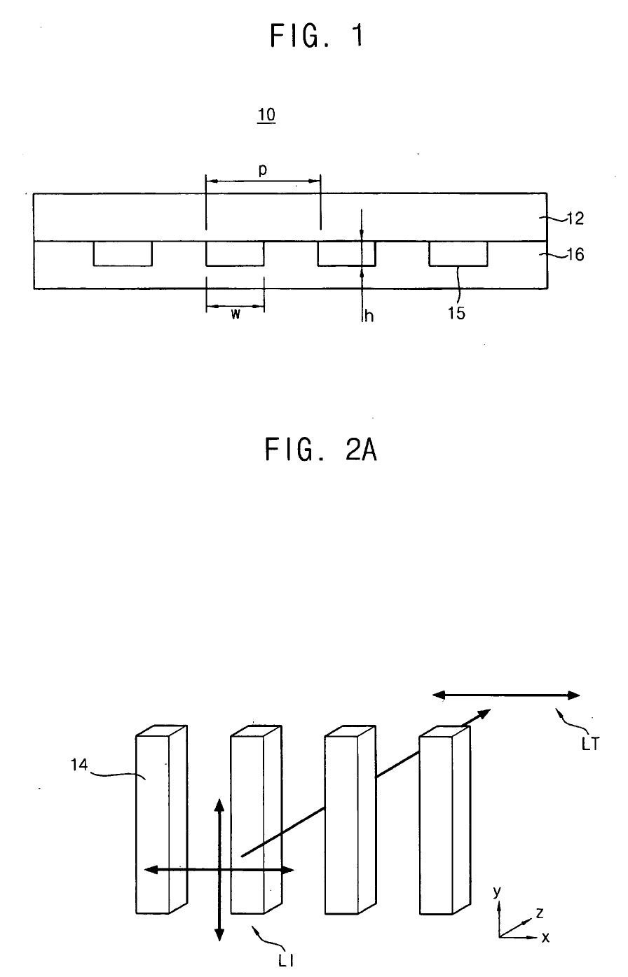

FIG. 1 is a cross-sectional view illustrating a hybrid-type polarizer in accordance with one embodiment of the present invention.

Referring to FIG. 1, the hybrid-type polarizer 10 includes a substrate 12, a polarizing color filter part 14 and a protecting layer 16. The polarizing color filter part 14 is on a rear surface of the substrate 12, and has a constant width ‘w’, a constant pitch ‘p’ and a constant height ‘h’. The protecting layer 16 covers the polarizing color filter part 14. A “rear” surface is intended to mean the surface that is on the opposite side as the main image-display surface.

The hybrid-type polarizer 10 may include a diffraction grating. Equation 1 represents a grating equation for a direct incident light.
n sin θₘ=m(λ/p) Equation 1

where n, θₘ, λ and p represent a refractive index, an m-th order diffraction angle, a wavelength of the direct incident light, and a period of the metal grating, respectively.

When a first order diffraction angle is greater than about 90°, the direct incident light is not diffracted, and the direct incident light becomes a zero-order diffraction light. That is, when the period p, the wavelength A and the refractive index n of the metal grating satisfy p<λ/n, the metal grating becomes a zero-order grating to generate the zero-order diffraction light. The zero-order grating is substantially the same as an optically homogeneous anisotropic thin film.

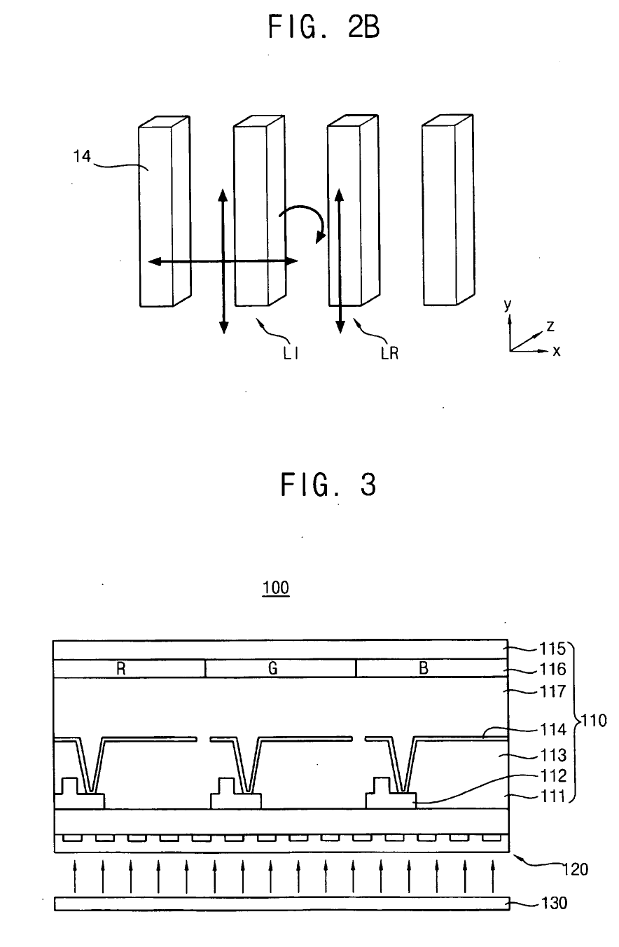

FIGS. 2A and 2B are perspective views illustrating transmission and reflection of a zero-order metal grating.

Referring to FIG. 2A, when a non-polarized incident light LI is incident on the metal grating 15, the metal grating 15 transmits a portion of the non-polarized incident light LI that vibrates substantially parallel with a grating vector of the metal grating 15. The grating vector of the metal grating 15 is substantially perpendicular to a metal wire of the metal grating 15. A transmitted light LT represents the portion of the non-polarized incident light LI that vibrates substantially parallel to the grating vector of the metal grating 15. In FIG. 2A, the transmitted light LT is polarized horizontally with respect to the figure. Each of the non-polarized incident light LI and the transmitted light LT propagates in the +Z-direction. In FIG. 2A, only horizontal and vertical portions of the non-polarized incident light LI is shown, however, the non-polarized incident light LI vibrates in various directions.

Referring to FIG. 2B, when the non-polarized incident light LI strikes the metal grating 15, the portion of the non-polarized incident light LI that vibrates substantially perpendicular to the grating vector of the metal grating 15 is reflected by the metal grating 15. The grating vector of the metal grating 15 is substantially perpendicular to the metal wire of the metal grating 15. A reflected light LR represents the portion of the non-polarized incident light LI that vibrates substantially perpendicular to the grating vector of the metal grating 15. In FIG. 2B, the reflected light LR is polarized vertically with respect to the figure. The transmitted light LT is reflected by the metal grating 14 to propagate in a -Z-direction.

Display Device

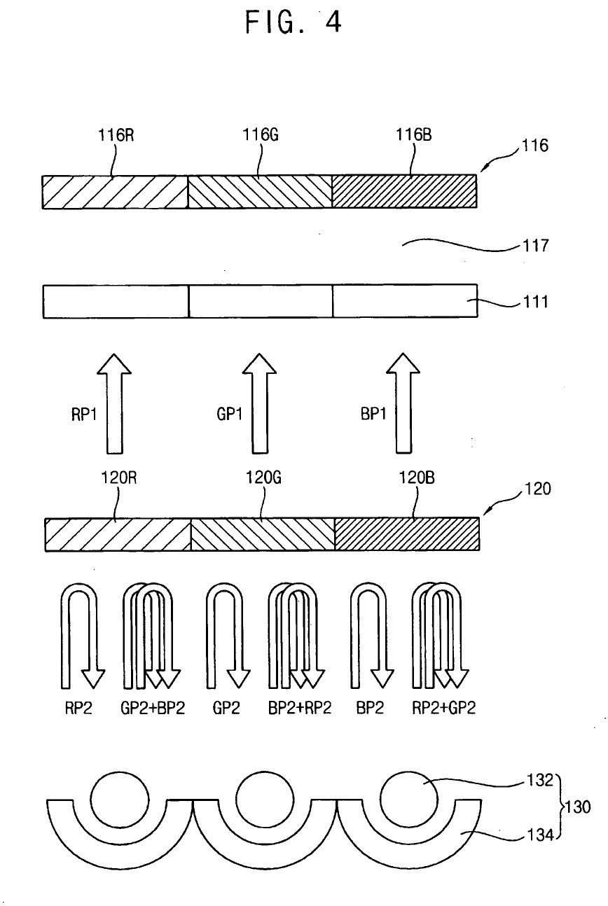

FIG. 3 is a cross-sectional view illustrating a display device having a hybrid-type polarizer in accordance with one embodiment of the present invention. FIG. 4 is a cross-sectional view illustrating an operation of the display device shown in FIG. 3. As will be explained, a metal grating functions as a reflective-type polarizer and a reflective-type color filter.

Referring to FIG. 3, the display device 100 includes a liquid crystal display (LCD) panel 110, a polarizing color filter member 120 and a backlight unit 130. The polarizing color filter member 120 is disposed under the LCD panel 110. The backlight unit 130 is disposed under the polarizing color filter member 120. The display device 100 includes a plurality of sub-pixels that produce red, green and blue colors.

The LCD panel includes an array substrate, a color filter substrate and a liquid crystal layer 117. The array substrate includes a first substrate 111, a switching element 112, an insulating layer 113 and a pixel electrode 114. The color filter substrate includes a second substrate 115 and a color filter layer 116 in each of the sub-pixels. The liquid crystal layer 117 is interposed between the array substrate and the color filter substrate.

The polarizing color filter member 120 includes a plurality of metal gratings. The polarizing color filter member 120 is disposed under the LCD panel 110. The size of each metal grating is determined by each of the red, green and blue sub-pixels. The red, green, and blue sub-pixels include red, green and blue metal gratings, respectively.

Table 1 represents the sizes of the red, green and blue metal gratings that correspond to the red, green and blue sub-pixels, respectively.

TABLE 1
Summary of metal grating sizes

| | Pitch (nm) | Width (nm) | Height (nm) |
|---|---|---|---|
| Red metal grating | 330 | 264 | 100 |
| Green metal grating | 220 | 165 | 100 |
| Blue metal grating | 200 | 150 | 80 |

Referring to Table 1, the pitches of the red, green and blue metal grating are about 330 nm, about 220 nm and about 200 nm, respectively. The widths of the red, green and blue metal grating are about 264 nm, about 165 nm, and about 150 nm, respectively. The heights of the red, green and blue metal grating are about 100 nm, about 100 nm and about 80 nm, respectively.

The backlight unit 130 is disposed on the rear of the polarizing color filter member 120 to supply the LCD panel 110 with light through the polarizing color filter member 120.

Now, the operation of the display device 100 using the light generated from the backlight unit 130 will be described.

Referring to FIGS. 3 and 4, when non-polarized light that includes red, green and blue wavelengths irradiates the red metal grating 120R that is in a first region, the red metal grating 120R transmits a first red polarized portion RP1 of the red light. However, a second red polarized portion RP2 of the red light, a first green polarized portion GP1 of the green light, a second green polarized portion GP2 of the green light, a first blue polarized portion BP1 of the blue light and a second blue polarized portion BP2 of the blue light are reflected by the red metal grating 120R. The first region corresponds to the red sub-pixel. Each of the first red polarized portion RP1, the first green polarized portion GP1 and the first blue polarized portion BP1 vibrates by moving in a direction substantially parallel to the grating vectors of each of the red, green and blue metal gratings 120R, 120G and 120B. In contrast, the second red polarized portion RP2, the second green polarized portion GP2 and the second blue polarized portion BP2 vibrate substantially perpendicularly to the grating vector of each of the red, green and blue metal gratings 120R, 120G and 120B. The grating vector of each of the red, green and blue metal gratings 120R, 120G and 120B are substantially perpendicular to a metal wire of each of the red, green and blue metal gratings 120R, 120G and 120B.

The first red polarized portion RP1 passes through the first substrate 111, as shown by the upward arrow in FIG. 4. The liquid crystal layer 117 and the red color filter 116R of the color filter substrate to display an image.

The second red polarized portion RP2 of the red light, the first green polarized portion GP1 of the green light, the second green polarized portion GP2 of the green light, the first blue polarized portion BP1 of the blue light and the second blue polarized portion BP2 of the blue light, all of which were reflected by the color filter layer 116R, propagate back to the backlight unit 130. Upon reaching the backlight unit 130, these light portions are reflected by a reflecting plate 134 toward the red metal grating 120R. Alternatively, the second red polarized portion RP2 of the red light, the first green polarized portion GP1 of the green light, the second green polarized portion GP2 of the green light, the first blue polarized portion BP1 of the blue light and the second blue polarized portion BP2 of the blue light may, upon reaching the reflecting plate 134, be reflected to propagate toward the green metal grating 120G or the blue metal grating 120B. In this case, portions of colored lights that did not transmit through the color filter layer 116R are “recycled” to increase the luminance of the display device 100.

When the non-polarized light that includes the red, green and blue wavelengths irradiates the green metal grating 120G that is in a second region, the green metal grating 120G transmits a first green polarized portion GP1 of the green light, as shown by the upward arrow in FIG. 4. However, a second green polarized portion GP2 of the green light, a first red polarized portion RP1 of the red light, a second red polarized portion RP2 of the red light, a first blue polarized portion BP1 of the blue light and a second blue polarized portion BP2 of the blue light are reflected from the green metal grating 120G. The second region corresponds to the green sub-pixel.

The first green polarized portion GP1 passes through the first substrate 111, the liquid crystal layer 117 and the green color filter 116G of the color filter substrate to display an image.

The second green polarized portion GP2 of the green light, the first red 15 polarized portion RP1 of the red light, the second red polarized portion RP2 of the red light, the first blue polarized portion BP1 of the blue light and the second blue polarized portion BP2 of the blue light, all of which are reflected by the green color filter 116G, reach the backlight unit 130 and are reflected by the reflecting plate 134 of the backlight unit 130 toward the green metal grating 120G. Alternatively, the second green polarized portion GP2 of the green light, the first red polarized portion RP1 of the red light, the second red polarized portion RP2 of the red light, the first blue polarized portion BP1 of the blue light and the second blue polarized portion BP2 of the blue light may be reflected by the reflecting plate 134 toward the red metal grating 120R or the blue metal grating 120B. In this case, portions of the colored 25 lights that did not transmit through the color filter layer 116G are “recycled” to increase the luminance of the display device 100.

When the non-polarized light that includes the red, green and blue lights irradiates the blue metal grating 120B that is in a third region, the blue metal grating 120B transmits a first blue polarized portion BP1 of the blue light. However, a second blue polarized portion BP2 of the blue light, a first red polarized portion RP1 of the red light, a second red polarized portion RP2 of polarized portion GP1 of the green light and a second green polarized portion GP2 of the green light are reflected from the blue metal grating 120B. The third region corresponds to the blue sub-pixel.

The first blue polarized portion BP1 passes through the first substrate 111, the liquid crystal layer 117 and the blue color filter 116B of the color filter substrate to display the image.

The second blue polarized portion BP2 of the blue light, the first red polarized portion RP1 of the red light, the second red polarized portion RP2 of the red light, the first green polarized portion GP1 of the green light and the second green polarized portion GP2 of the green light, all of which are reflected by the color filter layer 116B, propagate back to the backlight unit 130. Upon reaching the backlight unit 130, these light portions are reflected by the reflecting plate 134 of the backlight unit 130 toward the blue metal grating 120B. Alternatively, the BP2 of the blue light, the first red polarized portion RP1 of the red light, the second red polarized portion RP2 of the red light, the first green polarized portion GP1 of the green light and the second green polarized portion GP2 of the green light may be reflected by the reflecting plate 134 toward the red metal grating 120R or the green metal grating 120G. In this case, portions of the colored lights that did not transmit through the color filter layer 116B are recycled to increase the luminance of the display device 100.

Now, a reflection ratio and a transmission ratio of the hybrid-type polarizer will be described.

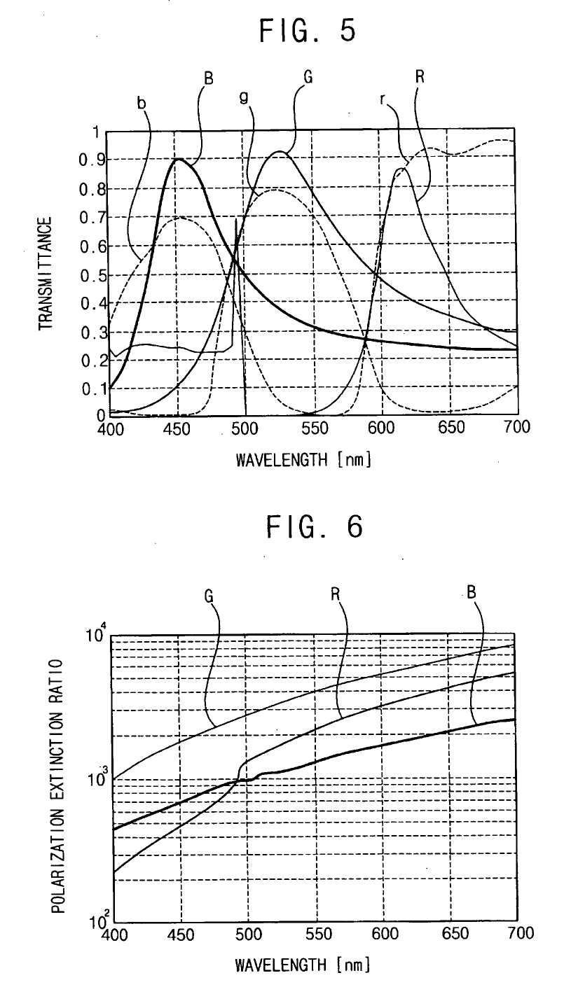

The reflection ratio and the transmission ratio are calculated by a rigorous coupled-wave analysis (RCWA). The results of the rigorous coupled-wave analysis (RCWA) are shown in FIGS. 5 and 6. Parameters of the red, green and blue metal gratings are substantially the same as those in Table 1. Light strikes the substrate while propagating through air. Light strikes the substrate from a direction that is substantially perpendicular to a surface of the substrate. Each of the red, green and blue metal gratings includes aluminum. The refractive index of each of the protecting layer and the LCD panel is about 1.5.

A first polarized portion p1 vibrates in a direction substantially parallel to the grating vector of each of the red, green and blue metal gratings. Each of the red, green and blue metal gratings extends in a direction substantially perpendicular to the grating vector. A second polarized portion p2 vibrates in a direction substantially perpendicular to the grating vector of each of the red, green and blue metal gratings. The second polarized portion p2 reflects off each of the red, green and blue metal gratings. A polarization extinction ratio is shown in FIG. 5 as a function of the wavelength of the light.

FIG. 5 is a graph comparing the light transmittance of a metal grating to the light transmittance of transmissive-type color filters as a function of wavelength. Solid lines represent the fraction of light that is transmitted through the red, green and blue metal gratings. Dotted lines represent the fraction of light that is transmitted through the transmissive-type red, green and blue color filters.

Referring to FIG. 5, light transmittance through the transmissive-type blue color filter having a wavelength of about 450 nm is about 70%. Light transmittance through the transmissive-type green color filter having a wavelength of about 520 nm is about 80%. Light transmittance through the transmissive-type red color filter having a wavelength of about 650 nm is about 90%. Each of the transmissive-type red, green and blue color filters absorbs the untransmitted portion of the light having different wavelengths. Thus, the light that exits the red, green, and blue color filters have wavelengths of about 650 nm, 520 nm and 450 nm, respectively, as shown by the three peaks in the plot of FIG. 5. This level of transmission is achieved even though each of the red, green and blue metal gratings is a reflective-type color filter.

The blue metal grating of the hybrid-type polarizer transmits 90% of blue light having a wavelength of about 450 nm. The green metal grating of the hybrid-type polarizer transmits 90% of a green light having a wavelength of about 520 nm. The red metal grating of the hybrid-type polarizer transmits 85% of a red light having a wavelength of about 650 nm.

The blue metal grating of the hybrid-type polarizer transmits about 20% more light than the transmissive-type blue color filter. The green metal grating of the hybrid-type polarizer transmits about 10% more light than the transmissive-type green color filter.

FIG. 6 is a graph illustrating the polarization extinction ratio as a function of wavelength, the wavelength being of a second polarized light that is polarized by the metal grating in accordance with one embodiment of the present invention.

Referring to FIG. 6, polarization extinction ratios of the red, green and blue lights are about 210, about 1,000 and about 450, respectively, at a wavelength of about 400 nm. Polarization extinction ratios of the red, green and blue lights are about 500, about 1,800 and about 700 in the wavelength range of about 450 nm. Polarization extinction ratios of the red, green, and blue lights are about 2,200, about 4,000 and about 1,500, respectively, at a wavelength of about 550 nm. Polarization extinction ratios of the red, green and blue lights are about 5,500, about 8,000 and about 2,600, respectively, in the wavelength range of about 700 nm. The polarization extinction ratios increase with wavelength.

The polarization extinction ratios of the hybrid-type polarizer in the visible wavelength range of about 400 nm to about 700 nm are at least in the hundreds, making the hybrid-type polarizer adequate for use in the LCD panel. The hybrid-type polarizer functions as a wire grid polarizer and the color filter that transmits the first polarized light p1 having a predetermined wavelength.

A surface plasmon is resonated with the light that is incident on a surface of each of the red, green and blue metal gratings to increase the amount of light that passed through an opening that is smaller than the wavelength of the incident light. The small opening is formed between the wires of each of the red, green and blue metal gratings.

When the first polarized portion p1 irradiates the red, green and blue metal gratings, each of the red, green and blue metal gratings functions as a bandpass filter. Therefore, light having the predetermined wavelength may pass through each of the red, green and blue metal gratings, and light having a wavelength different from the predetermined wavelength may be blocked by each of the red, green and blue metal gratings.

Referring again to FIG. 5, about 20% to about 30% of the light that is in the predetermined wavelength range is transmitted through the hybrid-type polarizer, and about 70% to about 80% of the light blocked by each of the red, green and blue metal gratings is reflected by each of the red, green and blue metal gratings. The reflected light is “recycled” to increase the luminance of the LCD device.

Optical characteristics of each of the red, green and blue metal gratings are determined by a pitch ‘p’, a height ‘h’, and a width ‘w’ of each of the red, green and blue metal gratings, a refractive index ‘n’ of a protecting layer, and the shape of each of the red, green and blue metal gratings, among other factors.

The optical characteristics of each of the red, green and blue metal gratings are optimized to increase the reflectivity of a second polarized portion p2, the transmittance of the first polarized portion p1, the color selectivity of each of the red, green and blue metal gratings, etc. The specific design of the hybrid-type polarizer may be determined by considering the manufacturing process, the optical characteristics, costs, etc.

Referring again to Table 1, the red metal grating has substantially the same height as the green metal grating, and the blue metal grating is shorter than the red and green metal gratings. In one embodiment, the blue metal grating may be shorter than each of the red and green metal gratings by about 20 nm. Therefore, an additional etching process may be required to form a master mold for forming the hybrid-type polarizer. The master mold may not be required in a conventional etching process. However, the master mold may be used multiple times to keep the manufacturing cost as low as possible.

When the hybrid-type polarizer that has the reflective-type polarizer is directly attached to a front side of the LCD panel, the contrast ratio of the LCD device decreases because of a decrease in the amount of externally provided light. An absorptive-type polarizer that deteriorates the optical characteristics does not decrease the contrast ratio based on the amount of the externally provided light, even though the absorptive-type polarizer is directly attached to the LCD panel. However, the reflective-type polarizer directly attached to the LCD panel may decrease the contrast ratio based on the amount of the externally provided light. Therefore, it is preferable to attach the hybrid-type polarizer to a rear side of the LCD panel.

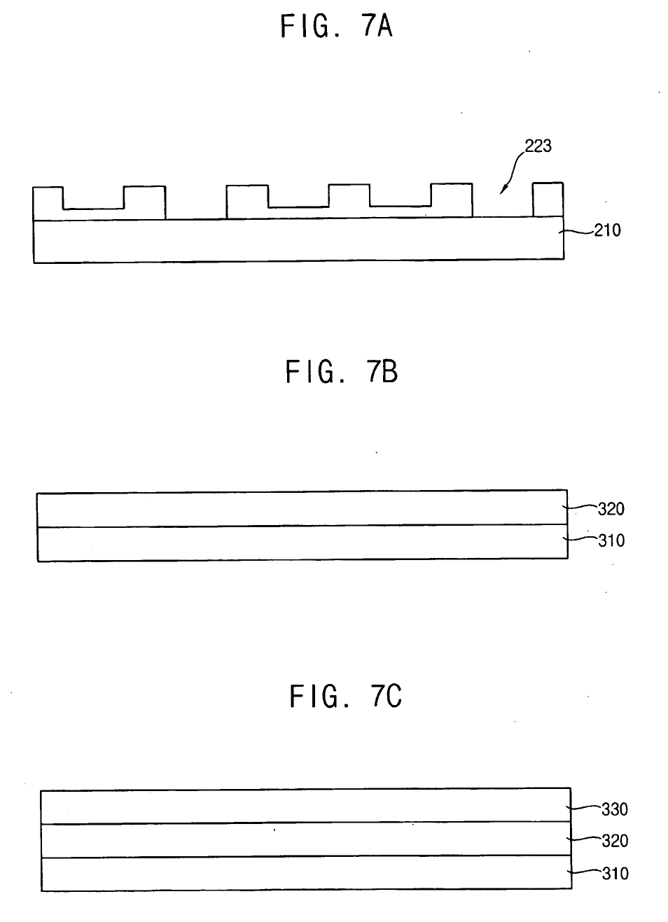

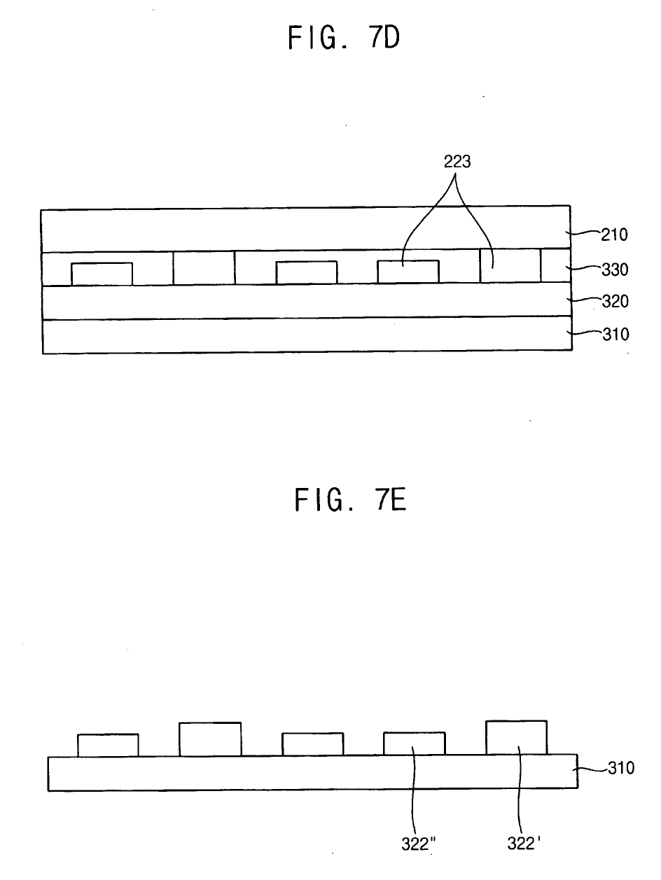

FIGS. 7A to 7E are cross-sectional views illustrating a method of manufacturing a hybrid-type polarizer in accordance with one embodiment of the present invention.

Referring to FIG. 7A, a master mold having a plurality of grooves 223 in first, second and third regions of a base 210 is prepared. The grooves 223 in the first, second and third regions have different sizes from each other.

The grooves 223 in the first region define the locations of red metal gratings that transmit a first red polarized portion of incident light. The groove depths are controlled such that the first red polarized portion of the incident light is transmitted and a second portion of the incident light in the first region is reflected by the red metal grating. The grooves 223 in the second region define the locations of green metal gratings that transmit a first green polarized portion of the incident light. The groove depths are controlled such that the first green polarized portion of the incident light is transmitted and a second portion of the incident light in the second region is reflected by the green metal grating. Similarly, the grooves 223 in the third region define the locations of blue metal gratings that transmit a first blue polarized portion of the incident light in the third region. The groove depths are controlled such that the first blue polarized portion of the incident light is transmitted and a second portion of the incident light is reflected by the blue metal grating.

Referring to FIG. 7B, a metal layer 320 is deposited on an array substrate 310. The array substrate 310 includes a plurality of thin film transistors TFT and a plurality of pixel electrodes. Alternatively, the array substrate 310 may be a base substrate for the array substrate 310 and may have the thin film transistors on it with or without the pixel electrodes.

Referring to FIG. 7C, an ultraviolet light curable polymer layer 330 is coated on the metal layer 320.

Referring to FIG. 7D, the master mold of FIG. 7A is placed on the ultraviolet-curable polymer layer.330 so that patterns of the master mold are imprinted on the ultraviolet-curable polymer layer 330 (shown in FIG. 7C). The patterns may include the grooves 223. The patterns of the master mold are printed on the ultraviolet-curable polymer layer 330. The master mold has the grooves 223 with different heights so that polymer protrusions having different heights are formed from the ultraviolet-curable polymer layer 330.

When ultraviolet light is irradiated onto the ultraviolet-curable polymer layer 330 including the protrusions of different heights, the ultraviolet-curable polymer layer 330 is cured and the protrusions are solidified. The ultraviolet-curable polymer layer 330 functions as an etching mask.

Referring to FIG. 7E, the metal layer 320 is partially removed using the ultraviolet-curable polymer layer 330 as a mask. In particular, the portion of the metal layer 320 corresponding to the parts of the ultraviolet-curable polymer layer 330 that are between the protrusions are etched to partially expose the array substrate 310. After the etching process, any remaining part of the ultraviolet-curable polymer layer 330 is removed. The unetched portion of the metal layer 320 that correspond to the taller polymer protrusions form first metal wires 322′. The unetched portion of the metal layer 320 that correspond to the shorter polymer protrusions is partially etched to form second metal wires 322″ that are shorter than the first metal wires 322′.

In FIG. 7E, the metal layer 320 is etched together with the ultraviolet-curable polymer layer 330. That is, the metal layer 320 and the ultraviolet-curable polymer layer 330 may be etched using the same etchant. Alternatively, the first and second metal wires 322′ and 322″ may be formed through a first etching process for removing the portion of the metal layer 320 that correspond to the areas between the adjacent protrusions of the ultraviolet-curable polymer layer 330. In this case, an ashing process for removing the smaller protrusions of the ultraviolet-curable polymer layer 330 and a second etching process for removing the portion of the metal layer 320 that correspond to the smaller protrusions of the ultraviolet-curable polymer layer 330 are also used. In FIGS. 7A to 7E, the ultraviolet-curable polymer layer 330 may be a positive photoresist. Alternatively, the ultraviolet-curable polymer layer 330 may be a negative photoresist.

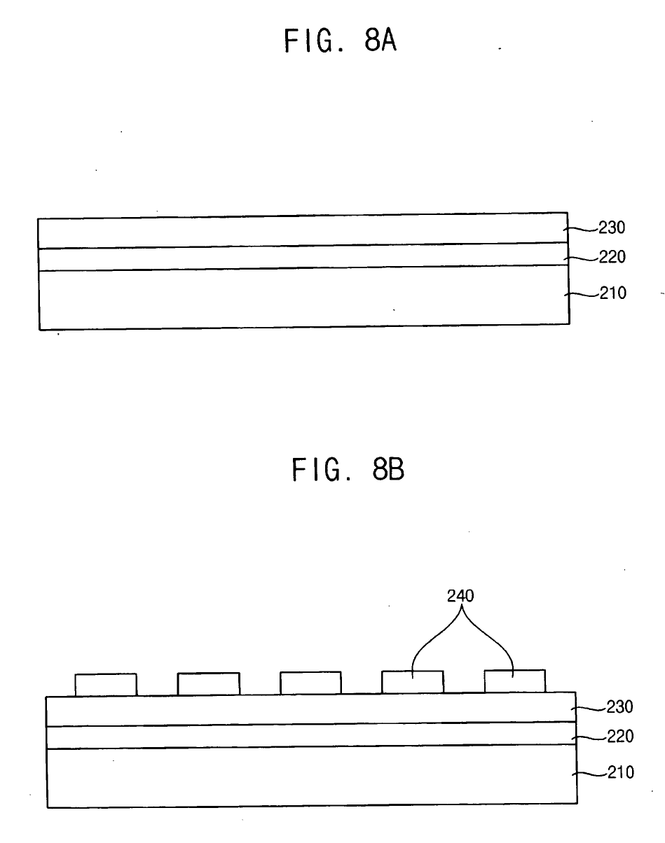

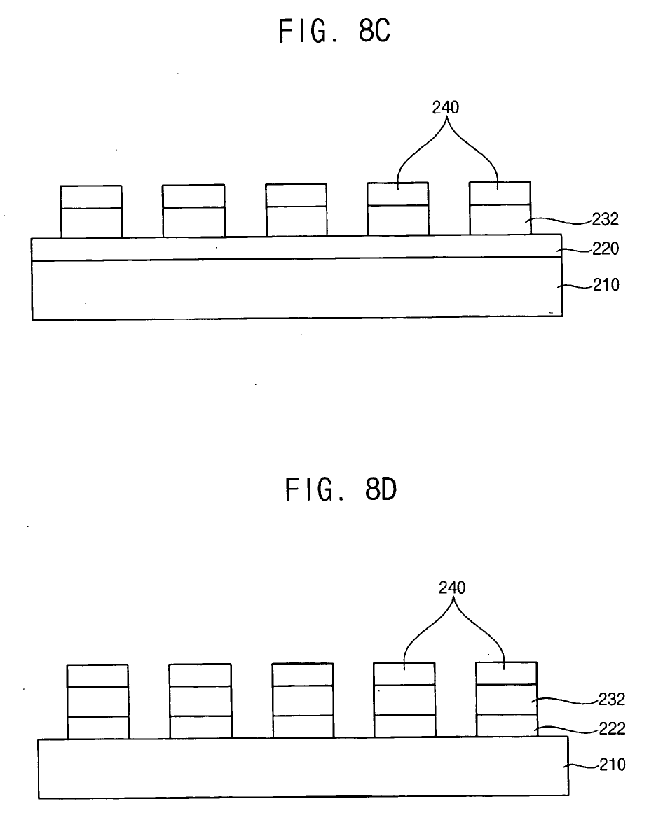

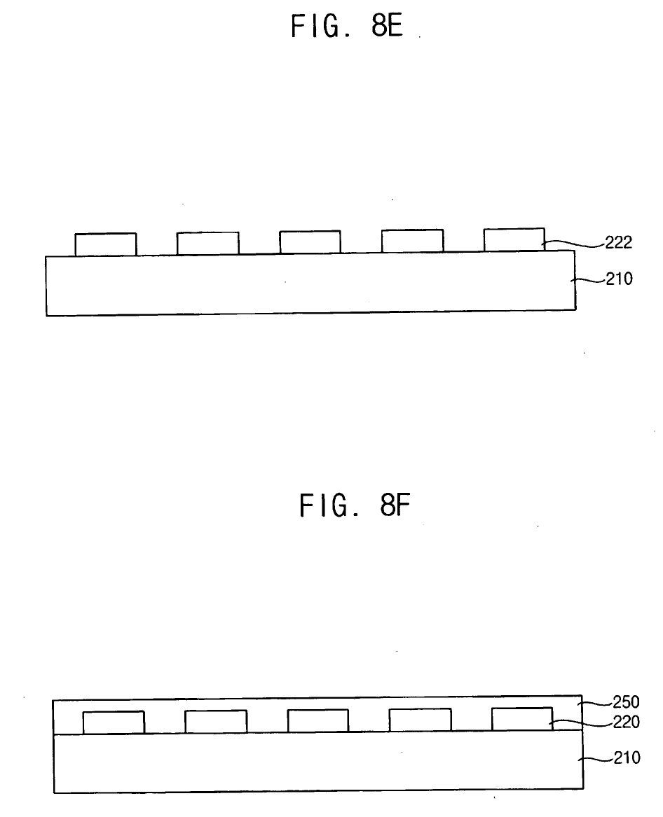

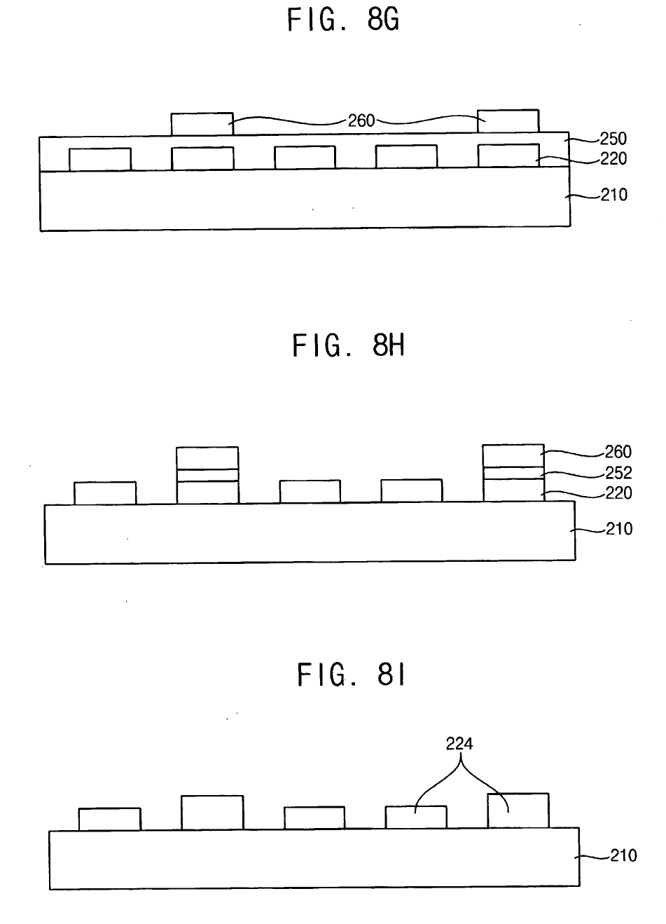

FIGS. 8A to 81 are cross-sectional views illustrating a method of manufacturing a master mold shown in FIG. 7A with alternative protrusions.

Referring to FIG. 8A, a silicon oxide layer 220 is deposited on the base 210. The base 210 may be a silicon substrate. A first metal layer 230 is deposited on the silicon oxide layer 220.

Referring to FIG. 8B, a photoresist layer (not shown) is coated on the first metal layer 230. A mask (not shown) is aligned on the photoresist layer (not shown). The photoresist layer (not shown) is exposed to a laser beam or an electron beam, and the exposed photoresist layer (not shown) is developed to form a first photoresist mask 240. The pitch and the width of the first photoresist mask 240 may be substantially the same as those of the red, green and blue metal gratings shown in FIG. 1.

Referring to FIG. 8C, the first metal layer 230 is etched in the areas defined by the first photoresist mask 240. A patterned first metal layer 232 is formed from the remaining portion of the first metal layer 230.

Referring to FIG. 8D, the silicon oxide layer 220 is etched in the areas defined by the first photoresist mask 240 and the patterned first metal layer 232. The unetched portions of the silicon oxide layer 220 form a patterned silicon oxide layer 222.

Referring to FIG. 8E, the first metal layer 232 is etched using a chromium etchant to form a preliminary master mold. The preliminary master mold has the patterned silicon oxide layer 222 formed on the base 210, and has a constant thickness.

Referring to FIG. 8F, a second metal layer 250 is deposited on the preliminary master mold at a constant thickness. The second metal layer 250 fills the spaces in the patterned silicon oxide layer 222 to planarize the preliminary master mold.

Referring to FIG. 8G, a photoresist layer (not shown) is coated on the second metal layer 250. A mask (not shown) is aligned on the photoresist layer (not shown). The photoresist layer (not shown) is exposed to a laser beam or an electron beam, and the exposed photoresist layer (not shown) is developed to form a second photoresist mask 260. The pitch and the width of the second photoresist mask 260 may be substantially the same as those of the second metal wire 7E.

Referring to FIG. 8H, the second metal layer 250 is etched using the second photoresist mask 260. The unetched portion of the second metal layer 250 form a patterned second metal layer 252.

Referring to FIG. 81, the patterned second photoresist mask 260 is removed to form the master mold including the protrusions 224 of different heights. The master mold may be cleaned by a surface treating agent to decrease any contamination of the master mold.

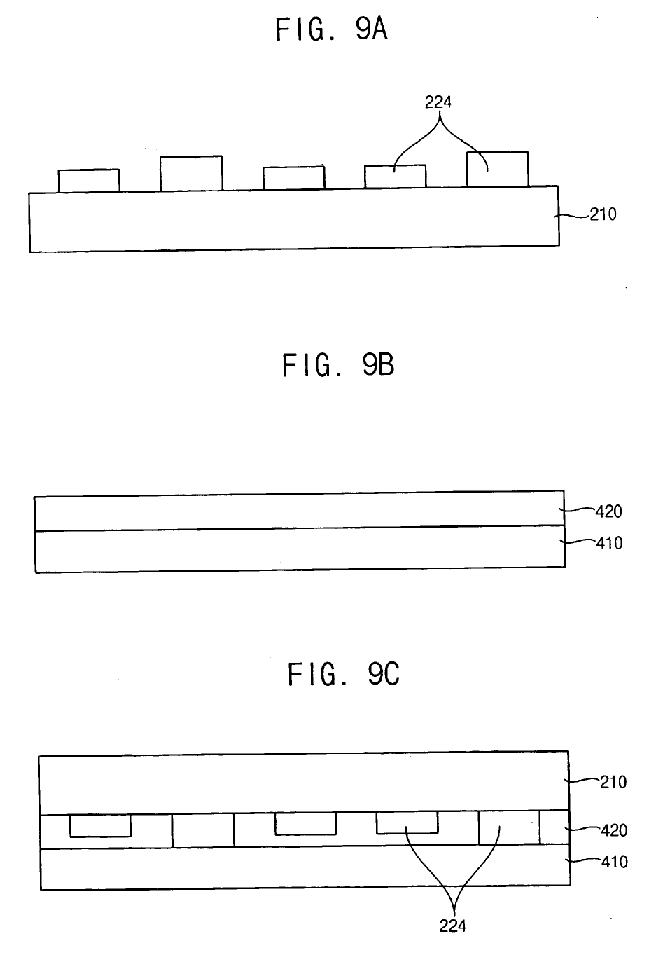

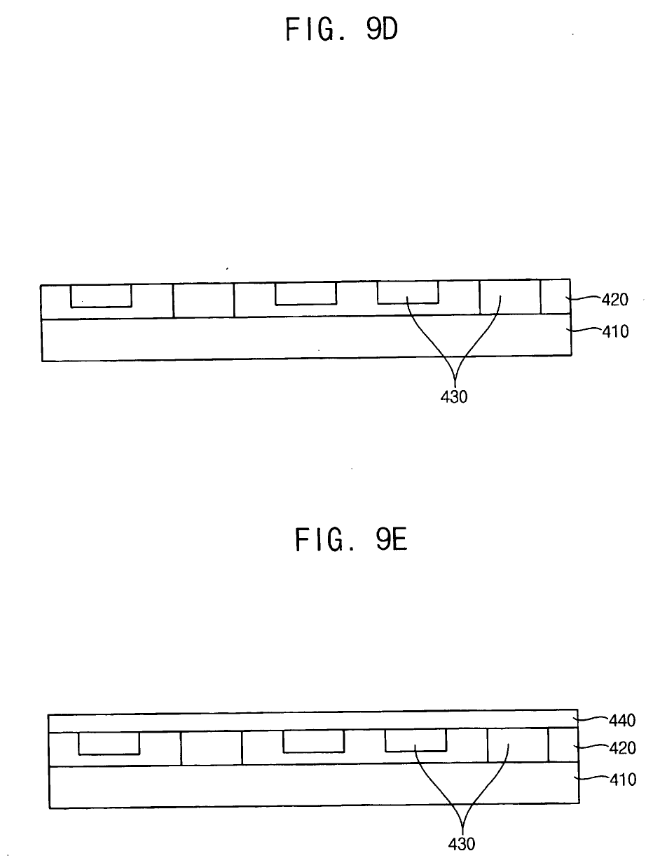

FIGS. 9A to 9E are cross-sectional views illustrating a method of manufacturing a hybrid-type polarizer in accordance with another embodiment of the present invention.

Referring to FIG. 9A, a master mold having a plurality of protrusions 224 in first, second and third regions of a base 210 is prepared. The protrusions 224 in the first, second and third regions have different sizes from each other. The master mold of FIG. 9A is the same as that which is described in reference to FIG. 7A (except for the protrusions), and FIG. 81. Thus, the same reference numerals will be used to refer to the same or like parts as those described in FIG. 7A and FIG. 81, and any redundant explanation concerning the above elements will be omitted.

Referring to FIG. 9B, an ultraviolet-curable polymer layer 420 is deposited on an array substrate 410. The array substrate 410 includes a plurality of thin film transistors TFT and a plurality of pixel electrodes. In some embodiments, the array substrate 410 may be a base substrate for the array substrate 410 and may have the thin film transistors TFT without the pixel electrodes.

Referring to FIG. 9C, the master mold of FIG. 9A is aligned on the ultraviolet-curable polymer layer 420 so that patterns of the master mold are imprinted on the ultraviolet-curable polymer layer 420 (shown in FIG. 9B). The patterns may be the protrusions 224. The master mold has protrusions 224 of different heights so that grooves having different depths are formed on the ultraviolet-curable polymer layer 420. Ultraviolet light is irradiated onto the ultraviolet-curable polymer layer 420 so that the ultraviolet-curable polymer layer 420 is solidified.

Referring to FIG. 9D, a metal layer (not shown) is deposited on the printed ultraviolet-curable polymer layer 420 to fill the grooves. An upper portion of the metal layer (not shown) is removed through a chemical mechanical polishing process or a wet etching process to form a patterned metal layer 430. The patterned metal layer 430 is filled in the grooves. The patterned metal layer 430 is not formed on an upper surface of the ultraviolet-curable polymer layer 420.

Referring to FIG. 9E, a protecting layer 440 is formed on the patterned metal layer 430 and the ultraviolet-curable polymer layer 420. The protecting layer 440 may have a constant thickness.

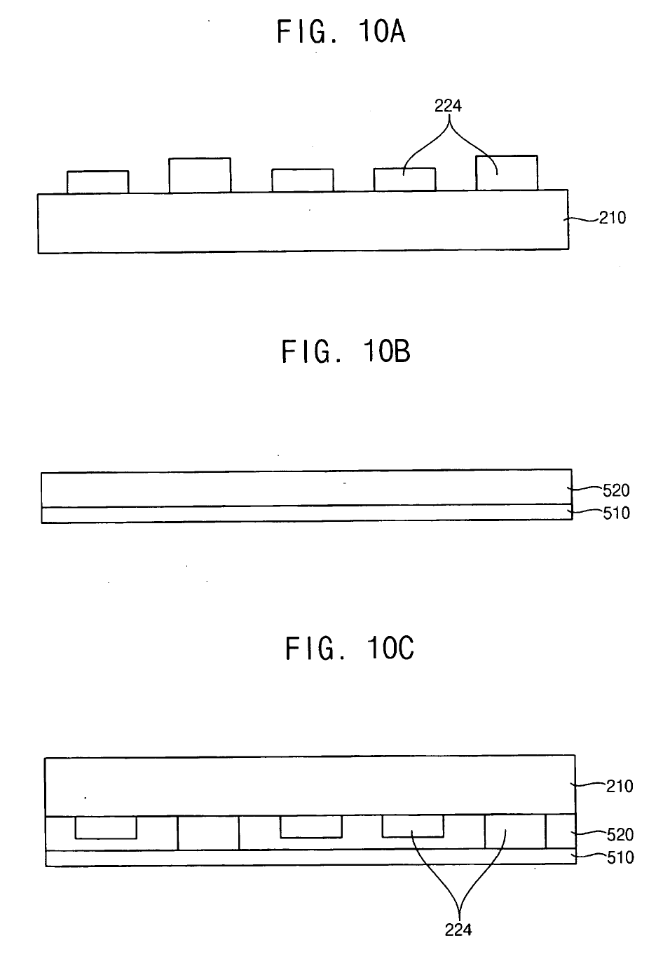

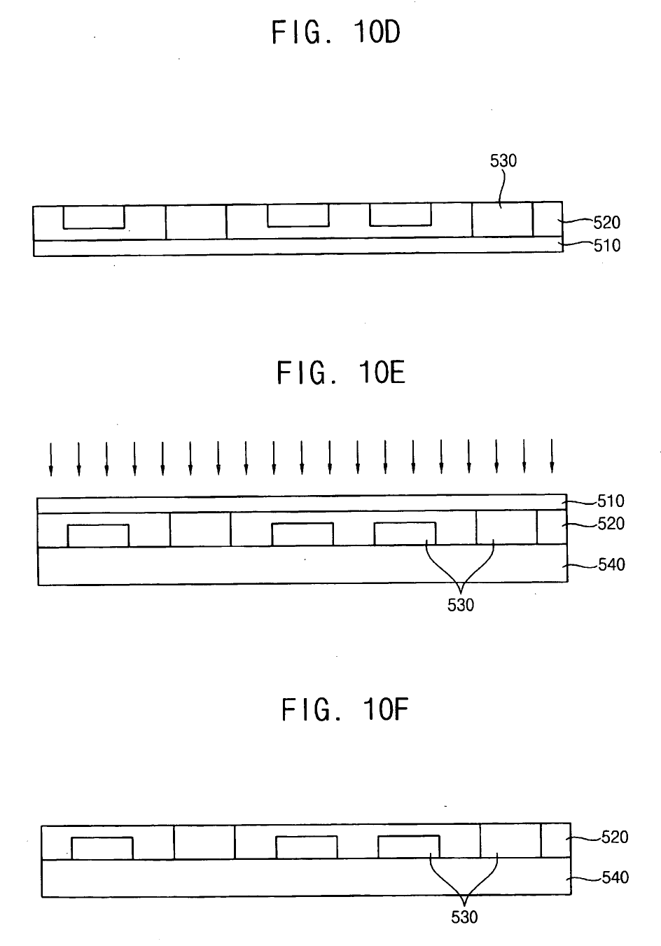

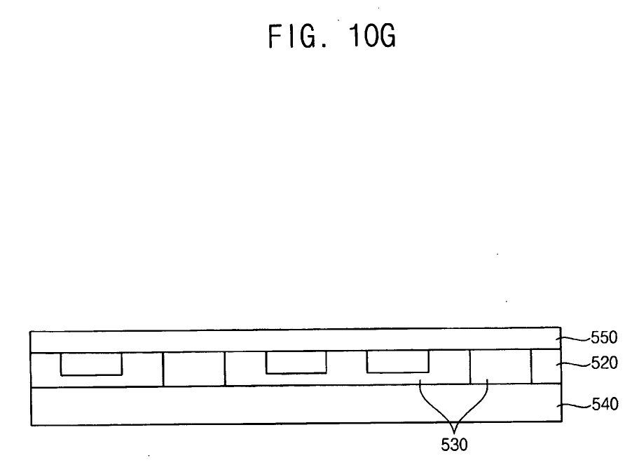

FIGS. 10A to 10G are cross-sectional views illustrating a method of manufacturing a hybrid-type polarizer in accordance with another embodiment of the present invention.

Referring to FIG. 10A, a master mold having a plurality of protrusions 224 in first, second and third regions of a base 210 is prepared. The protrusions 224 in the first, second and third regions have different sizes from each other. The master mold of FIG. 10A is the same as those described in FIGS. 81 and 9A and that of FIG. 7A except for the protrusions. Thus, the same reference numerals will be used to refer to the same or like parts as those described in FIGS. 81, 9A, and FIGS. 7A (except for the protrusions) and any further explanation concerning the above elements will be omitted.

Referring to FIG. 10B, an ultraviolet-curable polymer layer 520 is deposited on a base film 510. The ultraviolet-curable polymer layer 520 may be thicker than the base film 510.

Referring to FIG. 10C, the master mold of FIG. 10A is aligned on the ultraviolet-curable polymer layer 520 so that patterns of the master mold are imprinted on the ultraviolet-curable polymer layer 520 (shown in FIG. 10B). The patterns may be the protrusions 224. The master mold has the protrusions having different heights so that grooves having different depths are formed on the ultraviolet-curable polymer layer 520. Ultraviolet light is irradiated onto the ultraviolet-curable polymer layer 520 to solidify the ultraviolet-curable polymer layer 520.

Referring to FIG. 10D, a metal layer (not shown) is deposited on the printed ultraviolet-curable polymer layer 520 having the grooves to fill the grooves.

Referring to FIG. 10E, the base film 510 having the ultraviolet-curable polymer layer 420 and the patterned metal layer 530 is attached to an array substrate 540. The array substrate 510 includes a plurality of thin film transistors TFT and a plurality of pixel electrodes. Alternatively, the array substrate 510 may be a base substrate for the array substrate 510, the base substrate having the thin film transistors TFT with or without the pixel electrodes.

Referring to FIG. 10F, the base film 510 is removed from the ultraviolet-curable polymer layer 520 and the patterned metal layer 530.

Referring to FIG. 10G, a protecting layer 550 is coated on the patterned metal layer 530 and the ultraviolet-curable polymer layer 520. Therefore, the array substrate 540 having the hybrid-type polarizer is completed.

According to the present invention, the size and structure of the metal gratings are changed to control the polarization characteristics, the light transmittance, the reflectivity, the polarization extinction ratio, and the wavelength of the light. By controlling these parameters, the luminance of the backlight unit is improved.

In addition, the backlight unit includes metal grating to decrease a power consumption of the display device. Furthermore, the hybrid-type polarizer having the metal gratings has a greater transmittance/reflectivity, a greater polarization extinction ratio and a greater wavelength range than a conventional polarizer at a range of wavelengths including a radiowave range, a microwave range, etc. The conventional polarizer polarizes the light using refraction, anisotropy and polarizing characteristics.

Also, the hybrid-type polarizer has a simpler structure than a dual brightness enhancement film (DBEF) having hundreds of stacked layers. Thus, the hybrid-type polarizer has a lower manufacturing cost.

In addition, the metal gratings function as the reflective-type polarizer and the reflective-type color filter so that it polarizes light and “recycles” the remaining portion of the color light to increase the luminance.

This invention has been described with reference to the example embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A hybrid-type polarizer comprising:
a base member; and
a polarizing color filter member including a plurality of metal gratings in a plurality of regions of the base member, the metal gratings in the regions having different sizes from each other, the metal gratings in each of the regions transmitting a first portion of an incident light and reflecting a second portion of the incident light.

2. The hybrid-type polarizer of claim 1, further comprising a protecting layer that covers the metal gratings.

3. The hybrid-type polarizer of claim 2, wherein the protecting layer has substantially the same refractive index as the base member.

4. The hybrid-type polarizer of claim 1, wherein the metal gratings comprise aluminum.

5. The hybrid-type polarizer of claim 1, wherein the incident light strikes a surface of the base member from a direction that is substantially perpendicular to the surface.

6. The hybrid-type polarizer of claim 1, wherein the polarizing color filter member comprises:
a red metal grating part in a first region of the base member to transmit a first red polarized portion of the incident light and to reflect a second red polarized portion of the incident light, a first green polarized portion of the incident light, a second green polarized portion of the incident light, a first blue polarized portion of the incident light and a second blue polarized portion of the incident light;
a green metal grating part in a second region of the base member to transmit the first green polarized portion and to reflect the second green polarized portion, the first and second red polarized portions, and the first and second blue polarized portions; and
a blue metal grating part in a third region of the base member to transmit the first blue polarized portion and to reflect the second blue polarized portion, the first and second green polarized portions, and the first and second red polarized portions.

7. The hybrid-type polarizer of claim 6, wherein each of the first red, green and blue polarized portions vibrates in a direction substantially perpendicular to a length of the polarizing color filter member, and each of the second red, green and blue polarized portions vibrates in a direction substantially parallel to the length of the polarizing color filter member.

8. The hybrid-type polarizer of claim 6, wherein the blue metal grating part is shorter than each of the red and green metal grating parts.

9. The hybrid-type polarizer of claim 6, wherein the red metal grating part has a pitch of about 330 nm, a width of about 264 nm and a height of about 100 nm.

10. The hybrid-type polarizer of claim 6, wherein the green metal grating part has a pitch of about 220 nm, a width of about 165 nm and a height of about 100 nm.

11. The hybrid-type polarizer of claim 6, wherein the blue metal grating part has a pitch of about 200 nm, a width of about 150 nm and a height of about 80 nm.

12. The hybrid-type polarizer of claim 1, wherein the portion of the incident light that passed through the metal gratings vibrates in a direction substantially perpendicular to a length of the polarizing color filter member, and the second portion of the incident light that is reflected from the metal gratings vibrates in a direction substantially parallel to the length of the polarizing color filter member.

13. A method of manufacturing a hybrid-type polarizer comprising:
preparing a master mold including a plurality of patterns in first, second and third regions of a base, the patterns in the first, second and third regions having different sizes from each other;
depositing a metal layer on a substrate;
forming a polymer layer on the metal layer;
imprinting the patterns of the master mold on the polymer layer; and
partially etching the metal layer using the imprinted patterns of the polymer layer as an etching mask.

14. The method of claim 13, wherein the master mold comprises first patterns in the first region that transmit a first polarized portion of a first light and reflects a second polarized portion of the first light.

15. The method of claim 14, wherein the first light comprises one of a red light, a green light and a blue light.

16. The method of claim 14, wherein the first polarized portion comprises a portion that is polarized in the first direction.

17. The method of claim 13, wherein the patterns in one of the first, second and third regions has a smaller size than the patterns in other regions.

18. The method of claim 13, wherein the polymer layer comprises a positive photoresist.

19. A method of manufacturing a hybrid-type polarizer comprising:
preparing a master mold including a plurality of protrusions in first, second and third regions of a base, the protrusions in the first, second and third regions having different sizes from each other;
forming a polymer layer on a substrate;
imprinting the protrusions of the master mold on the polymer layer to form grooves in the polymer layer;
depositing a metal layer on the imprinted polymer layer, the metal layer filling the grooves;
planarizing the metal layer through a chemical mechanical polishing or a wet etching so that a portion of the printed polymer layer is exposed; and
coating a protecting layer on the exposed polymer layer and the metal layer.

20. A method of manufacturing a hybrid-type polarizer comprising:
preparing a master mold including a plurality of protrusions in first, second and third regions of a base, the protrusions in the first, second and third regions having different sizes from each other;
forming a polymer layer on a base;
imprinting the protrusions of the master mold on the polymer layer to form grooves in the polymer layer;
depositing a metal layer on the imprinted polymer layer, the metal layer filling the grooves;
attaching a substrate so that the metal layer contacts the substrate;
detaching the base film from the polymer layer; and
coating a protecting layer on the polymer layer.

21. A display device comprising:
a backlight unit generating light;
a liquid crystal display panel on the backlight unit, the liquid crystal display panel including two substrates and a liquid crystal layer interposed between the two substrates; and
a hybrid-type polarizer interposed between the backlight unit and the liquid crystal display panel, the hybrid-type polarizer including:
a base member; and
a polarizing color filter member including a plurality of metal gratings in a plurality of regions of the base member, the metal gratings in the regions having different sizes from each other, the metal gratings in each of the regions transmitting a first portion of the light and reflecting a second portion of the light.

22. The display device of claim 21, wherein the backlight unit comprises a reflecting plate that receives the second portion of the light that is reflected by the metal gratings and reflects the received light.

23. The display device of claim 21, wherein the hybrid-type polarizer is integrally formed on a lower surface of the liquid crystal display panel.

24. A method of manufacturing a hybrid-type polarizer comprising:
depositing a silicon oxide layer on a substrate;
depositing a first metal layer on the silicon oxide layer;
coating a first photoresist layer on the first metal layer;
selectively removing portions of the first photoresist layer to form a first photoresist mask;
etching the first metal layer and the silicon oxide layer using the first photoresist mask to form a first patterned metal layer and a patterned silicon oxide layer;
removing the first photoresist mask and the first patterned metal layer to expose the patterned silicon oxide layer;
depositing a second metal layer over the patterned silicon oxide layer, the second metal layer having a planar surface;
forming a second photoresist layer on the second metal layer and patterning the second photoresist layer to form a second photoresist mask, the second photoresist mask protecting less surface than the first photoresist mask;
etching the second metal layer using the second photoresist mask to form a second patterned metal layer, wherein the second patterned metal layer is formed only on select parts of the patterned silicon oxide layer; and
removing the second photoresist mask to leave tall protrusions and short protrusions, tall protrusions made of the patterned silicon oxide layer and the second patterned metal layer and the short protrusions made of the patterned silicon oxide layer.
